(19) United States
(12) Patent Application Publication
(10) Pub. No.: US 2007/0061707 A1
(43) Pub. Date: Mar. 15, 2007

(54) Method, system, and computer program product for providing virtual views in an on-demand portal infrastructure

(75) Inventors: Kevin L. Sally, Markham (CA); Christopher P. Goodwin, Surfside, FL (US); Christian X. Voth, Markham (CA)

Correspondence Address: HOFFMAN WARNICK & DALESSANDRO LLC, 75 STATE ST, 14TH FLOOR, ALBANY, NY, 12207, US

(73) Assignee: INTERNATIONAL BUSINESS MACHINES CORPORATION, Armonk, NY (US)

(21) Appl. No.: 11/227,935

(22) Filed: Sep. 15, 2005

(51) Int. Cl. G06F 17/00; G06F 9/00

(52) U.S. Cl. 715/513; 715/742; 715/760; 715/744

(57) ABSTRACT

The present invention provides a method, system, and computer program product for providing virtual views in an on-demand portal infrastructure. The method comprises: receiving one of a plurality of different virtual view identifiers; retrieving a site profile associated with the received virtual view identifier; and uniquely rendering a concrete portal site based on information in the site profile to generate a virtual view of the concrete portal site, wherein a different virtual view of the concrete portal site is rendered for each of the plurality of different virtual view identifiers.

### BACKGROUND OF THE INVENTION

1. Field of the Invention

The present invention generally relates to portals. More particularly, the present invention provides a method, system, and computer program product for providing virtual views in an on-demand portal infrastructure.

2. Related Art

Today's portal solutions require that each portal definition be a unique entity. However, within large organizations, there are many commonalities between a large number of portals. These commonalities can include, for example, the portal navigation, personalization, and entitlement structure that contribute to the look and feel of the portals. The cost to manage the many portals (potentially thousands) on an individual basis proves to be a costly process. Further, there is not a manageable way on an enterprise level to transition from thousands of unique portal views into a single adaptive portal with thousands of variations based on unique aspects of a customer. In short, one way is too costly to maintain with production resources and the other way is not achievable from a business perspective since there is required uniqueness for customers.

One current solution allows for a portal to be copied/derived. However, any change made to the primary/parent portal must then be replicated through to all of the child portals, which can be a very complex, time consuming, and cumbersome process.

### SUMMARY OF THE INVENTION

In general, the present invention provides a method, system, and computer program product for providing virtual views in an on-demand portal infrastructure. In particular, the present invention provides a single physical portal definition that supports multiple virtual views that are customizable and personalizable.

Initially, a physical portal definition model is created, which includes the navigation structure, page layout, and default portlet configurations of a “concrete” portal site. Next, multiple virtual views are created based on the concrete portal site. Each virtual view includes its own unique definition model, identified by a unique virtual view identifier, that includes, for example, an URL, entitlement access, enabled/disabled features of the concrete portal site, and customization. Through the use of entitlement on the URL level, each virtual view can have varying degrees of access which may be different from that of other virtual views based on the same physical portal definition model. Customization is the means by which each virtual view can take on a different look/feel. Customization of a virtual view is accomplished using a Site Profile describing what content should be rendered and where. The Site Profile affects what pages are available (which affects navigation), what portlet instances are displayed on a page (e.g., a portlet instance can be either rendered or suppressed), and how the portlet instances behave (e.g., what content they render and what options they make available). Further customization and personalization of each virtual view can also be provided using one or more additional types of profiles.

A first aspect of the present invention is directed to a method for providing virtual views, comprising: receiving one of a plurality of different virtual view identifiers; retrieving a site profile associated with the received virtual view identifier; and uniquely rendering a concrete portal site based on information in the site profile to generate a virtual view of the concrete portal site, wherein a different virtual view of the concrete portal site is rendered for each of the plurality of different virtual view identifiers.

A second aspect of the present invention is directed to a system for providing virtual views, comprising: a system for receiving one of a plurality of different virtual view identifiers; a system for retrieving a site profile associated with the received virtual view identifier; and a system for uniquely rendering a concrete portal site based on information in the site profile to generate a virtual view of the concrete portal site, wherein a different virtual view of the concrete portal site is rendered for each of the plurality of different virtual view identifiers.

A third aspect of the present invention is directed to a program product stored on a computer readable medium for providing virtual views, the computer readable medium comprising program code for performing the following steps: receiving one of a plurality of different virtual view identifiers; retrieving a site profile associated with the received virtual view identifier; and uniquely rendering a concrete portal site based on information in the site profile to generate a virtual view of the concrete portal site, wherein a different virtual view of the concrete portal site is rendered for each of the plurality of different virtual view identifiers.

A fourth aspect of the present invention provides a method for deploying an application for providing virtual views, comprising: providing a computer infrastructure being operable to: receive one of a plurality of different virtual view identifiers; retrieve a site profile associated with the received virtual view identifier; and uniquely render a concrete portal site based on information in the site profile to generate a virtual view of the concrete portal site, wherein a different virtual view of the concrete portal site is rendered for each of the plurality of different virtual view identifiers.

A fifth aspect of the present invention provides computer software embodied in a propagated signal for providing virtual views, the computer software comprising instructions to cause a computer system to perform the following functions: receive one of a plurality of different virtual view identifiers; retrieve a site profile associated with the received virtual view identifier; and uniquely render a concrete portal site based on information in the site profile to generate a virtual view of the concrete portal site, wherein a different virtual view of the concrete portal site is rendered for each of the plurality of different virtual view identifiers.

### BRIEF DESCRIPTION OF THE DRAWINGS

These and other features of this invention will be more readily understood from the following detailed description of the various aspects of the invention taken in conjunction with the accompanying drawings in which:

FIG. 1 depicts a flow diagram of a method in accordance with an embodiment of the present invention.

FIG. 2 depicts an illustrative concrete portal site in accordance with an embodiment of the present invention.

FIG. 3 depicts a first virtual view of the concrete portal site of FIG. 2, generated in accordance with an embodiment of the present invention.

FIG. 4 depicts a second virtual view of the concrete portal site of FIG. 2, generated in accordance with an embodiment of the present invention.

FIG. 5 depicts an example of a content node tree and context tree for mapping URL context paths to specify hidden nodes in a Site Profile.

FIG. 6 depicts a flow diagram of a method for accessing a virtual view in accordance with an embodiment of the present invention.

FIG. 7 depicts a flow diagram of an illustrative process for receiving a request for a virtual view and determining which portlet instances should be displayed in accordance with an embodiment of the present invention.

FIG. 8 depicts a flow diagram of an illustrative process for the evaluating/rendering of portlet instances in accordance with an embodiment of the present invention

FIG. 9 depicts an illustrative computer system for implementing a method in accordance with an embodiment of the present invention.

The drawings are merely schematic representations, not intended to portray specific parameters of the invention. The drawings are intended to depict only typical embodiments of the invention, and therefore should not be considered as limiting the scope of the invention. In the drawings, like numbering represents like elements.

### DETAILED DESCRIPTION OF THE INVENTION

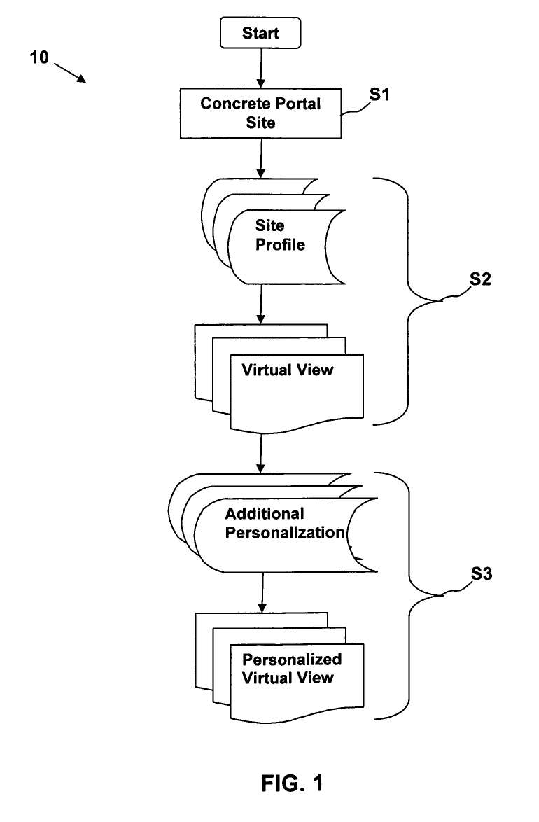

A flow diagram 10 of a method in accordance with an embodiment of the present invention is depicted in FIG. 1. In step S1, a concrete portal site comprising a page structure/hierarchy and a navigation structure is generated. Each page in the concrete portal site can include one or more portlet instances. In step S2, a plurality of virtual views are created by customizing the concrete portal site generated in step S1 in accordance with a plurality of predefined Site Profiles. A Site Profile affects what pages are available (which affects navigation), what portlet instances are displayed on a page (e.g., a portlet instance can be either rendered or suppressed), and how the portlet instances behave (e.g., what content they render and what options they make available). In optional step S3, further customization can applied to each virtual view created in step S2 to generate personalized virtual views. The further customization can be based, for example, on a Campaign Profile, a User Profile, and/or session settings. A Campaign Profile is similar to a Site Profile except that it has a time period during which it is effective. During this time period, the Campaign Profile overrides the Site Profile attributes. The User Profile provides the identity (e.g., username/password) of a user, which dictates the specific information that a user can see in a virtual view. Session settings are session-scoped attributes that override User Profile attributes, but only for the duration of a user's session.

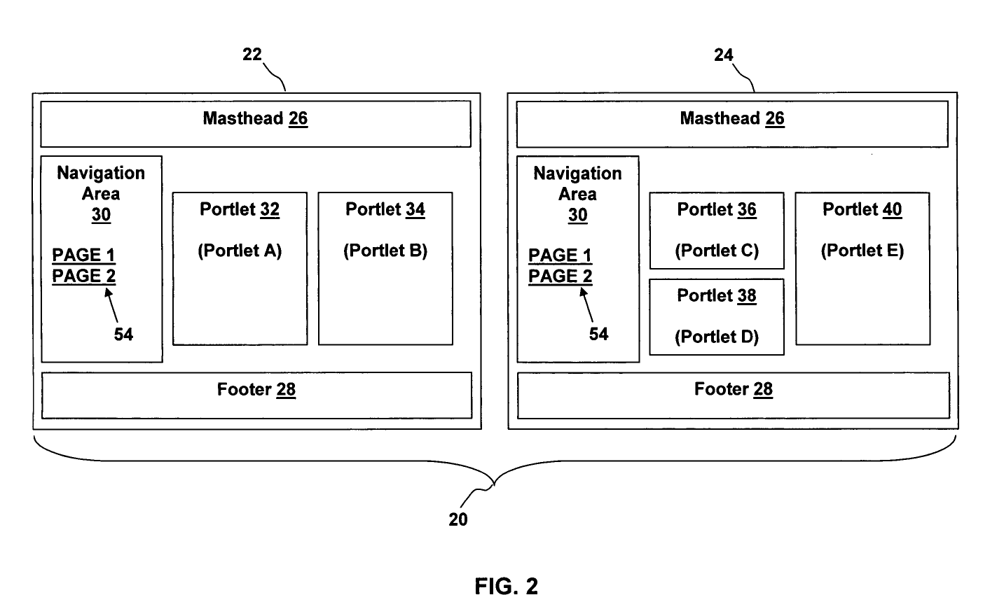

Virtual views are used to display the same concrete portal site in a plurality of different ways. Each virtual view is associated with a unique virtual view identifier that is used to access a store of information for the virtual view. This information is analyzed and used during the rendering stage of the concrete portal site in order to display the virtual view. An example of the generation of two different virtual views based on the same concrete portal site is presented below with reference to FIGS. 2-4.

An illustrative concrete portal site 20 in accordance with an embodiment of the present invention is illustrated in FIG. 2. The concrete portal site 20 includes a first page 22 and a second page 24, shown side-by-side for descriptive purposes only. The first and second pages 22, 24 have the following sections in common: masthead 26, footer 28, and navigation area 30. The first page 22 includes a first portlet instance 32 (Portlet A) and a second portlet instance 34 (Portlet B). The second page 24 includes a first portlet instance 36 (Portlet C), a second portlet instance 38 (Portlet D), and a third portlet instance 40 (Portlet E). It is assumed that each portlet instance 32, 34, 36, 38, 40 (Portlets A-E) contains a different type of content (not shown). It is also assumed that at least two Site Profiles exist, namely Site Profile A and Site Profile B, which are associated with the virtual view identifiers “A” and “B,” respectively.

A first user (User 1) wishes to render the concrete portal site 20 based on the virtual view identifier “A.” During the render phase, the virtual view identifier “A” is analyzed and the Site Profile A associated with the virtual view identifier “A” is retrieved. The Site Profile A includes the following information:

(a) Suppress (do not render or make available for view) the second page 24;

(b) Suppress (do not render) the portlet instance 34 (Portlet B) on the first page 22;

(c) Display a logo 42 (“IBM”) in the masthead 26 of the first page 22; and

(d) Display a copyright notice 44 (“©2005 IBM”) in the footer 28 of the first page 22.

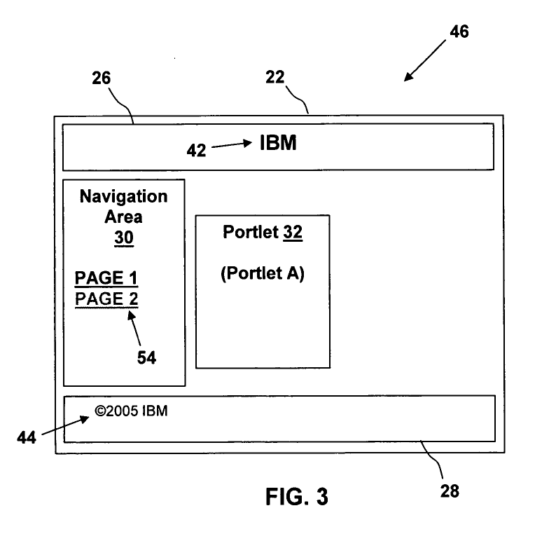

The resultant virtual view 46 generated using the concrete portal site 20 and based on the Site Profile A is illustrated in FIG. 3.

A second user (User 2) wishes to render the same concrete portal site 20 based on a different virtual view identifier, i.e., the virtual view identifier “B.” During the render phase, the virtual view identifier “B” is analyzed and the Site Profile B associated with the virtual view identifier “B” is retrieved. The Site Profile B includes the following information:

(a) Suppress (do not render) the portlet instance 32 (Portlet A) on the first page 22, and the portlet instance 40 (Portlet E) on the second page 24.

(b) Display a logo 48 comprising an image in the masthead 26 of the first and second pages 22, 24; and

(c) Display a copyright notice 50 (“©2005 Company XYZ”) in the footer 28 of the first and second pages 22, 24.

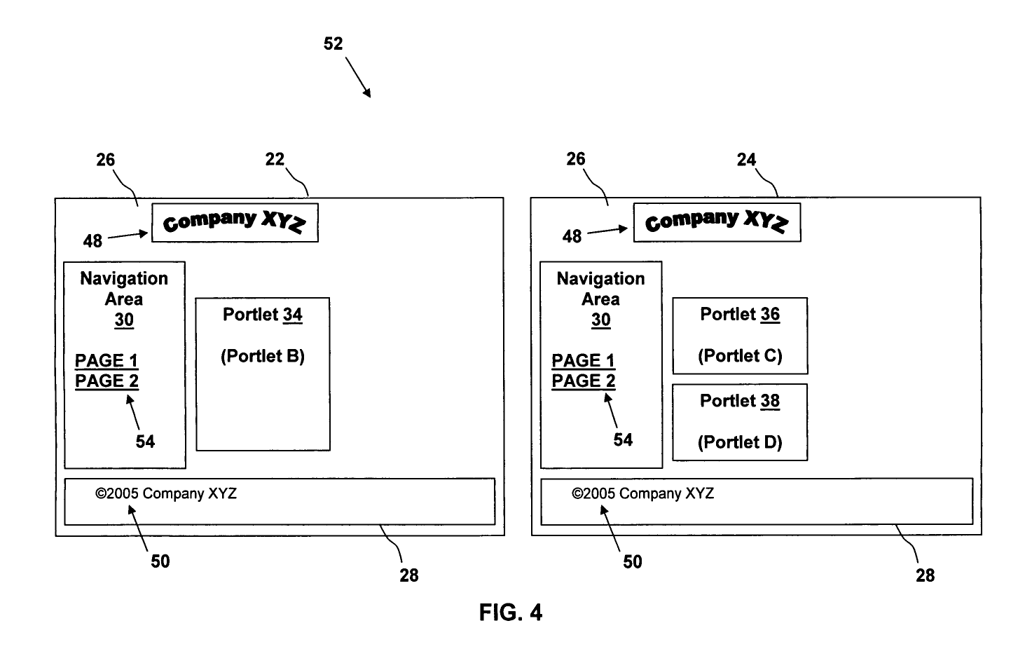

The resultant virtual view 52 generated using the concrete portal site 20 and based on the Site Profile B is illustrated in FIG. 4. Again, the first and second pages 22, 24 are shown side-by-side for descriptive purposes only.

Comparing FIGS. 3 and 4, it can be seen that the concrete portal site 20 has been rendered differently for User 1 and User 2. Advantageously, although User 1 and User 2 accessed the same concrete portal site 20, their user experience and look/feel were markedly different because of the use of the different virtual view identifiers “A” and “B,” and the different Site Profiles, i.e., Site Profile A and Site Profile B, associated with the virtual view identifiers “A” and “B,” respectively.

Since the virtual views 46, 52 were generated from the same concrete portal site 20, they have the same navigation node hierarchy 54 displayed in the navigation area 30. While the same navigation node hierarchy 54 is shared among the virtual views 46, 52, a Site Profile may suppress one or more of the nodes so that they cannot be accessed by any user, either anonymous or authenticated. For any virtual view based on that Site Profile, a page corresponding to a suppressed node simply does not exist. This is illustrated in FIG. 3 where the link to “Page 2” in the navigation area 30 of the virtual view 46 has been grayed-out (i.e., it cannot be selected), because Site Profile A has suppressed the rendering of the second page 24 (Page 2). Alternatively, the link to “Page 2” could be removed from the navigation area 30 of the virtual view 46.

In order to display a concrete portal site differently, a user must specify a virtual view identifier. By specifying the virtual view identifier, the user is identifying which virtual view of the concrete portal site they wish to render/view.

A virtual view identifier can be specified in a variety of ways. For example, a virtual view identifier can be specified on the request for a virtual view. Specifying a virtual view identifier on the request involves adding the virtual view identifier to the end of the Universal Resource Locator (URL) of the concrete portal site being accessed. For example, an URL of http://www.ibm.com/proxy/sitename would become http://www.ibm.com/proxy/sitename?viewID=xxx where xxx is the virtual view identifier. The virtual view identifier xxx can comprise any combination of characters (e.g., viewID=123 or viewed=IBM).

A virtual view identifier can also be specified in a session. In this way, the specified virtual view identifier will persist for as long as the user has their browser session open. This technique can be combined with the URL-based specification of a virtual view identifier. To this extent, the virtual view identifier specified in the URL can be stored in the session object and can be used until the session is terminated or until a different virtual view identifier is specified on a request, whichever comes first. If a virtual view identifier is specified, then the new one is stored in the session, and so on.

The Site Profile referenced by a virtual view identifier stores the information needed to render a specific virtual view from a concrete portal site. The Site Profile is made available to users of the request/session (e.g., as a java object). The Site Profile is populated when a request is made for a virtual view, and can contain information including, but not limited to:

(a) A list of portlet instances that are not to be displayed for the virtual view;

(b) A list of pages that are not to be displayed for the virtual view;

(c) The path to a file (e.g., a logo) that is to be displayed for the virtual view (e.g., in a page or portlet); and

(d) Any specific information pertaining to theme display (color, size, etc.) for the virtual view.

A mechanism is provided to retrieve the specific information that has been stored for a Site Profile referenced by a virtual view identifier. This can be accomplished, for example, by intercepting the HyperText Transport Protocol (HTTP) request and performing some additional custom processing. This process is called Servlet Filtering/Chaining. Other techniques for retrieving the information are also possible.

A Servlet Filter is an extra bit of processing that can be added to the normal servlet request chain. A Servlet Filter specifies a custom class, and that custom class can perform some processing. Any changes that are made to the HTTP request by a Servlet Filter are also available to all downstream operations. An example of the operation of a Servlet Filter comprises:

(a) Read the virtual view identifier (viewID) from the HTTP request (if available);

(b) Store the viewID in the session;

(c) Retrieve the information associated with the viewID (i.e., the Site Profile); and

(d) Store the Site Profile for future components to make use of (alternatively store the Site Profile in the session as well).

Since a virtual view is based on a concrete portal site, it has the same navigation node structure. One or more virtual views can be based on the same concrete portal site, but not all virtual views need to include all the nodes (pages, labels, URLs, etc.) in the navigation node structure of the concrete portal site. As such, a virtual view has the ability to hide/suppress nodes from its users (anonymous or authenticated).

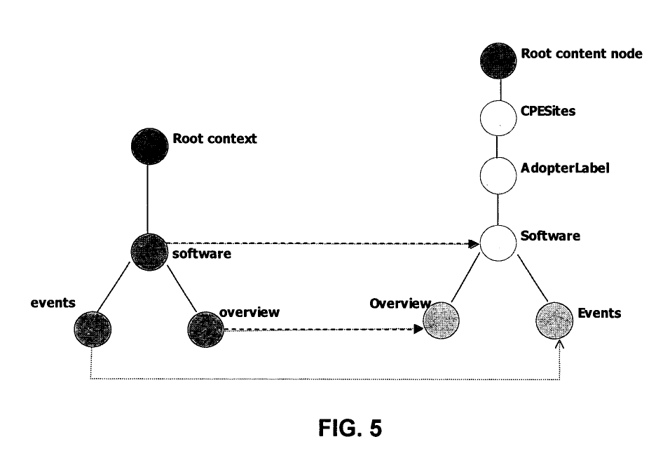

To prevent a user of a virtual view from accessing hidden nodes, the hidden nodes can be prevented from appearing in the navigation menu (e.g., navigation area 30, FIG. 2), navigation trail menu, graphic tabs, etc. Each virtual view specifies the hidden nodes in its Site Profile. Mapping URL context paths can be used to specify hidden nodes in the Site Profile. FIG. 5 shows an example of a content node tree and context tree, where the lines from content nodes to context tree nodes show the mapping context of the content nodes. The mapping URL context path of the Overview node is /software/overview and that of the Events node is/software/events. If the Events node is to be hidden in a virtual view then its context path /software/events will be specified in the Site Profile as a hidden node.

Entitled nodes are nodes in a navigation node structure of a virtual view that are only accessible to users who belong to one or more particular virtual view visitors groups. Like hidden nodes, entitled nodes are specified in the Site Profile of a virtual view. To access an entitled node, a user must be logged in and must be a valid user of one of the virtual view visitors group(s).

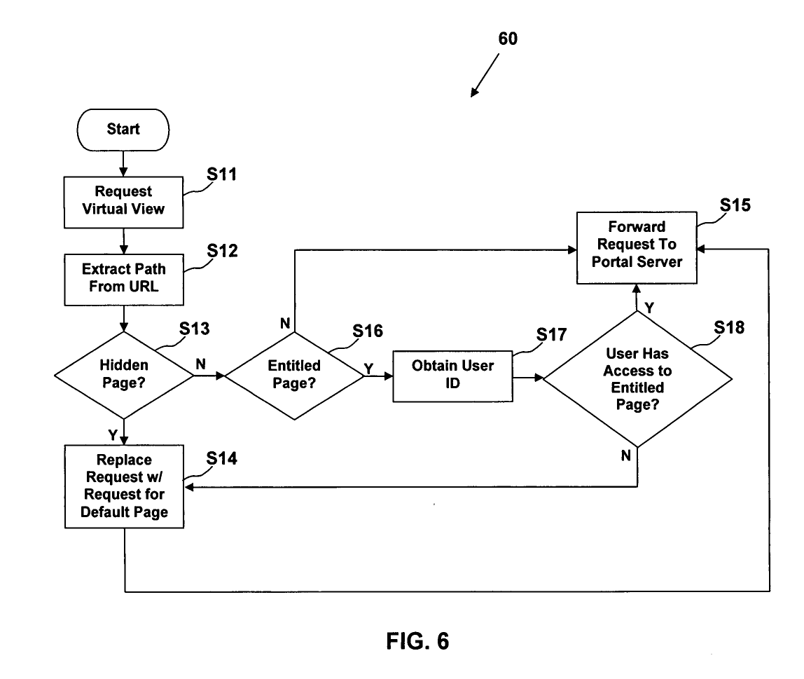

When a hidden page of a virtual view is accessed for whatever reason, a default page of the virtual view will be returned (multiple default pages can exist depending on desired behavior). The Mapping URL Context path of the default page will be specified in the Site Profile. The default page cannot be a hidden page. The Servlet Filter inspects the URL associated with an HTTP request to determine if the HTTP request is for one of the hidden pages. If so, the HTTP request is replaced with a request for the default page. The default page is also displayed when an entitled node is accessed by an unauthorized user. A flow diagram 60 depicting this process is illustrated in FIG. 6.

In step S11 of the flow diagram 60, a user requests a virtual view (e.g., using an URL). The path of the virtual view is extracted from the URL in step 12. If, in step S13, it is determined that the path is equal to the context path of a hidden page, then the request for the virtual view is replaced in step S14 with a request for a default page. Flow then passes to step S15, where the request for the default page is forwarded to a portal server. If, in step S13, it is determined that the path is not equal to the context path of a hidden page, then the entitlement status of the page is determined in step S16. If, in step S16, it is determined that the path is equal to the context path of an entitled page, then an ID of the user is obtained in step S17 and flow passes to step S18. Otherwise, flow passes to step S15, where the request for the virtual view is forwarded to a portal server. If, in step S18, the ID of the user indicates that the user has access to the entitled page, then the request for the virtual view is forwarded to a portal server. Otherwise, the request for the virtual view is replaced in step S14 with a request for a default page and, in step S15, the request for the default page is forwarded to a portal server.

As described above, the portlet instances within a concrete portal site are conditionally rendered based on the Site Profile. In particular, the Site Profile is populated with a list of portlet instances that should not be displayed in a virtual view. This list is defined by the full object ID of each portlet instance, which is a unique identifier of the portlet instance across the entire portal.

The rendering of a portlet instance can be controlled, for example, by a WebSphere Portal Server (WPS) skin. Within the skin being used for rendering a particular portlet instance, use can be made of a custom JavaServer Pages (JSP) tag, which will do the following:

(a) Determine if the portlet instance it is about to render is in the list of portlet instances which should not be rendered. This can be done by determining the object ID of the current portlet instance and comparing it to the list of predefined portlet instances which are to be hidden (e.g., based on virtual view configuration and/or entitlement).

(b) If the two object IDs match, then this portlet instance should not be displayed. The skin will not render the portlet instance.

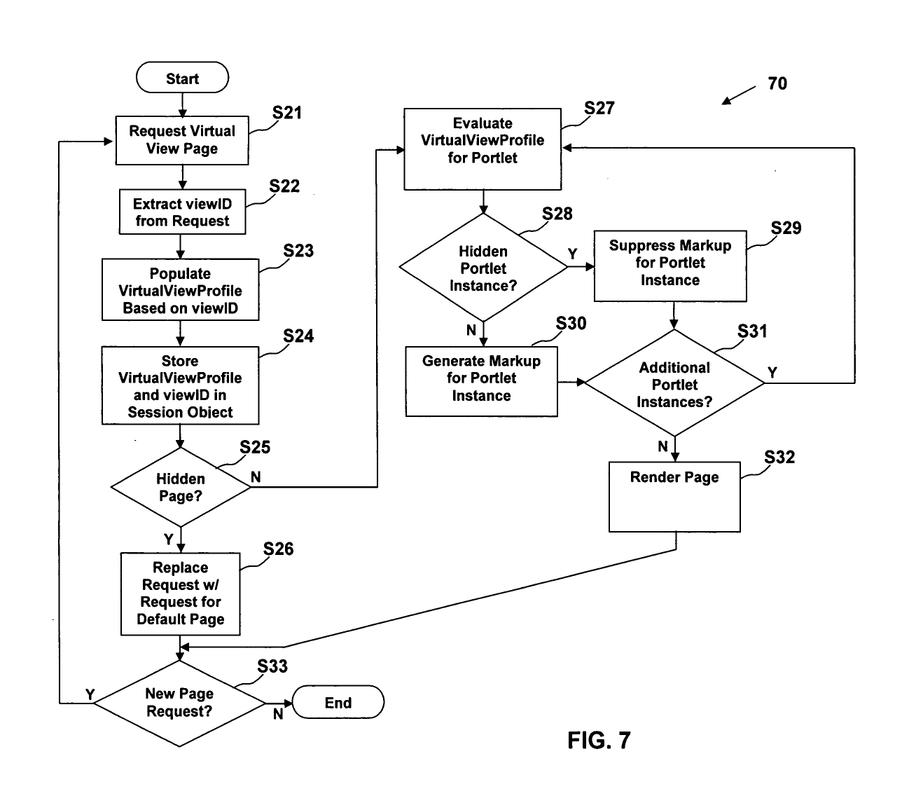

FIG. 7 depicts a flow diagram 70 of an illustrative process for receiving a request for a virtual view page and determining which portlet instances should be displayed in the requested virtual view page in accordance with an embodiment of the present invention. In step S21, a user makes a request for a page of a virtual view. In this example the request is provided as follows: http://www.ibm.com/largeenterprisesite?viewID=Ontario. In step S22, a Servlet Filter is executed as part of the processing. The Servlet Filter recognizes that “Ontario” has been passed as the virtual view identifier (viewID) on the request. In step S23, the Servlet Filter instantiates a VirtualViewProfile object (Site Profile) and populates it, for example, by reading an eXtensible Markup Language (XML) file or reading from a database using the key “Ontario.” In step S24, the VirtualViewProfile and viewID are stored in a session object.

At the point of rendering a page, the following process can take place:

(a) In step S25, the VirtualViewProfile object is examined to determine if the current requested page is present in the list of pages that should be hidden. If the page should be hidden, then the default page is displayed in step S26. If the page should not be hidden, then flow passes to step S27.

(b) In step S27, the VirtualViewProfile object is evaluated for a portlet instance, and flow passes to step S28. If the current portlet instance is determined in step S28 to be present in the list of portlet instances that should be hidden, then the markup for the current portlet instance is suppressed in step S29. When the markup is not generated, the page will appear as if the current portlet instance did not exist. Other portlet instances on the page can be shifted up and/or left to compensate for the blank space corresponding to the hidden portlet instance. If the current portlet instance is not to be hidden, then markup for the current portlet instance is generated in step S30.

(c) If there are more portlet instances to render (step S31), then flow passes back to step S27. If not, flow passes to step S32 where the page is rendered.

(d) If there is a request for another page of the virtual view (step S33), then flow passes back to step S21. Otherwise, processing ends.

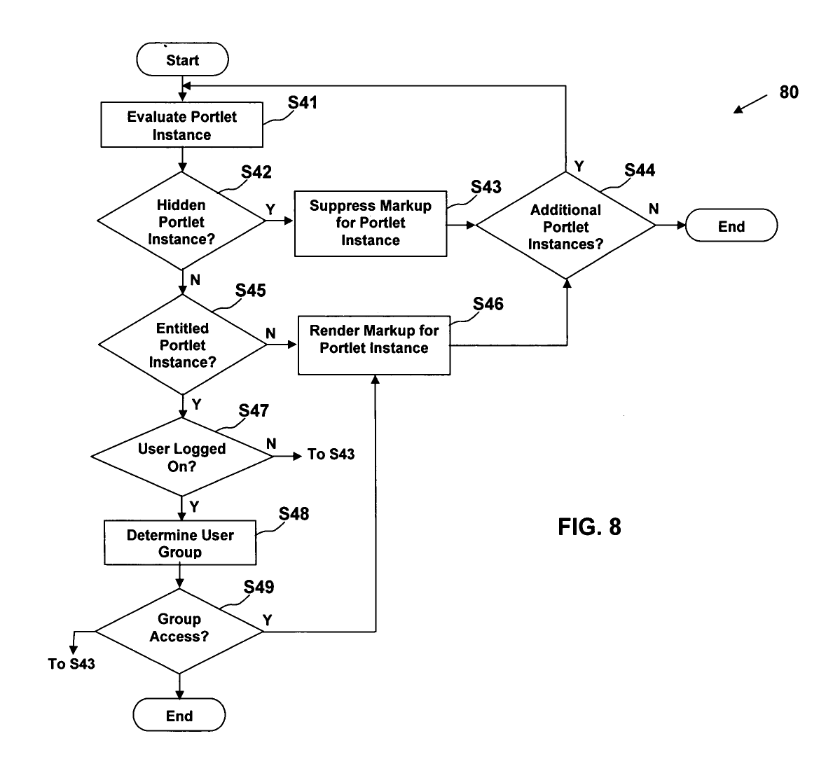

Portlet instances can also be conditionally displayed in a virtual view based on user entitlement, in a manner similar to that described above with regard to the use of entitled pages. For example, a user may have to be signed in or part of a particular group in order to view a particular portlet instance. Entitled portlet instances are identified in a Site Profile. During the rendering stage of the virtual view, each portlet instance will be examined to see if it is an entitled portlet instance. A flow diagram 80 illustrating the evaluation/rendering of portlet instances in accordance with another embodiment of the present invention is illustrated in FIG. 8.

In step S41, a portlet instance is evaluated. If the portlet instance is determined to be a hidden portlet instance in step S42, then flow passes to step S43, where the markup for the hidden portlet instance is suppressed. If there are additional portlet instances (step S44), flow passes back to step S41. Otherwise the process ends.

If the portlet instance is determined not to be a hidden portlet instance in step S42, then flow passes to step S45, where it is determined whether the portlet instance is entitled. If the portlet instance is not entitled, the markup for the hidden portlet instance is rendered in step S46. If, however, the portlet instance is determined to be entitled in step S45, then flow passes to step S47, where it is determined whether there is a user profile established (i.e., the user is logged on). If so, flow passes to step S48. If not, the portlet instance is treated as a suppressed portlet instance and the markup for the portlet instance is suppressed in step S43.

In step S48, the group to which the user belongs is determined. If this group is entitled (step S49) to view the portlet instance, then flow passes to step S46 and the portlet instance is rendered. If not, the markup for the portlet instance is suppressed in step S43.

Theme elements in a virtual view can also be conditionally rendered in a manner similar to portlet instances. That is, one or more theme elements can be hidden or suppressed based on user entitlement.

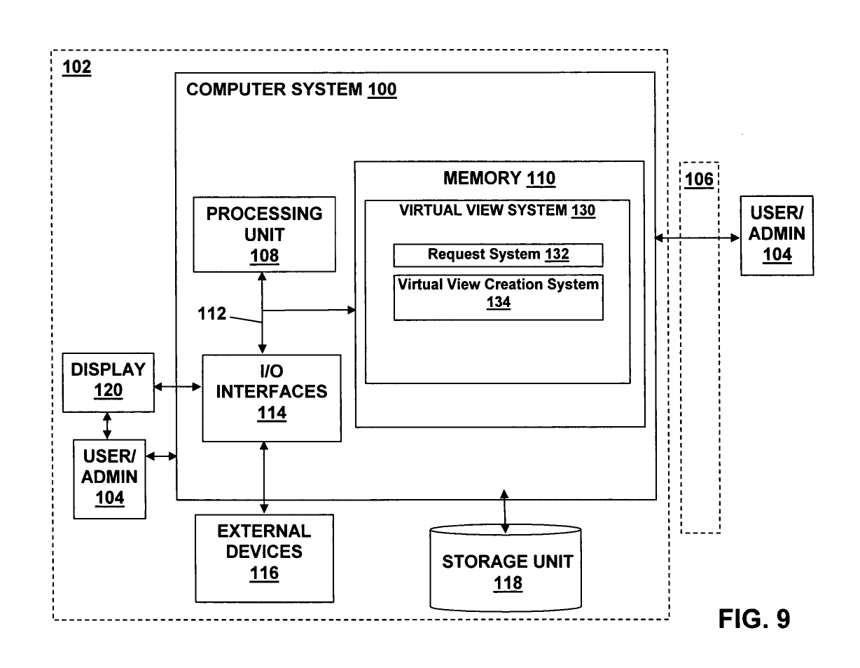

A computer system 100 for providing virtual views in an on-demand portal infrastructure in accordance with an embodiment of the present invention is depicted in FIG. 9. Computer system 100 is provided in a computer infrastructure 102. Computer system 100 is intended to represent any type of computer system capable of carrying out the teachings of the present invention. For example, computer system 100 can be a laptop computer, a desktop computer, a workstation, a handheld device, a server, a cluster of computers, etc. In addition, as will be further described below, computer system 100 can be deployed and/or operated by a service provider that provides virtual views in an on-demand portal infrastructure in accordance with the present invention. It should be appreciated that a user/administrator 104 can access computer system 100 directly, or can operate a computer system that communicates with computer system 100 over a network 106 (e.g., the Internet, a wide area network (WAN), a local area network (LAN), a virtual private network (VPN), etc). In the case of the latter, communications between computer system 100 and a user-operated computer system can occur via any combination of various types of communications links. For example, the communication links can comprise addressable connections that may utilize any combination of wired and/or wireless transmission methods. Where communications occur via the Internet, connectivity can be provided by conventional TCP/IP sockets-based protocol, and an Internet service provider can be used to establish connectivity to the Internet.

Computer system 100 is shown including a processing unit 108, a memory 110, a bus 112, and input/output (I/O) interfaces 114. Further, computer system 100 is shown in communication with external devices/resources 116 and one or more storage unit 118. In general, processing unit 108 executes computer program code, such as failure system 130, that is stored in memory 110 and/or storage system(s) 118. While executing computer program code, processing unit 108 can read and/or write data, to/from memory 110, storage system(s) 118, and/or I/O interfaces 114. Bus 112 provides a communication link between each of the components in computer system 100. External devices/resources 116 can comprise any devices (e.g., keyboard, pointing device, display (e.g., display 120, printer, etc.) that enable a user to interact with computer system 100 and/or any devices (e.g., network card, modem, etc.) that enable computer system 100 to communicate with one or more other computing devices.

Computer infrastructure 102 is only illustrative of various types of computer infrastructures that can be used to implement the present invention. For example, in one embodiment, computer infrastructure 102 can comprise two or more computing devices (e.g., a server cluster) that communicate over a network (e.g., network 106) to perform the various process steps of the invention. Moreover, computer system 100 is only representative of the many types of computer systems that can be used in the practice of the present invention, each of which can include numerous combinations of hardware/software. For example, processing unit 108 may comprise a single processing unit, or can be distributed across one or more processing units in one or more locations, e.g., on a client and server. Similarly, memory 110 and/or storage system 116 can comprise any combination of various types of data storage and/or transmission media that reside at one or more physical locations. Further, I/O interfaces 114 can comprise any system for exchanging information with one or more external devices/resources 116. Still further, it is understood that one or more additional components (e.g., system software, math co-processor, cache memory, etc.) not shown in FIG. 9 can be included in computer system 100. However, if computer system 100 comprises a handheld device or the like, it is understood that one or more external devices/resources 116 (e.g., a display) and/or one or more storage unit(s) 118 can be contained within computer system 100, and not externally as shown.

Storage system(s) 118 can be any type of system (e.g., a database) capable of providing storage for information under the present invention. Such information can include, for example, concrete portal sites, portlets, Site Profiles, etc. To this extent, storage system(s) 118 can include one or more storage devices, such as a magnetic disk drive or an optical disk drive. In another embodiment, storage system(s) 118 can include data distributed across, for example, a local area network (LAN), wide area network (WAN) or a storage area network (SAN) (not shown). Although not shown, additional components, such as cache memory, communication systems, system software, etc., may be incorporated into computer system 100. Moreover, although not shown, computer systems operated by user/administrator 104 can contain computerized components similar to those described above with regard to computer system 100.

Shown in memory 110 (e.g., as a computer program product) is a virtual view system 130 for providing virtual views in accordance with an embodiment of the present invention. Virtual view system 130 includes a request system 132 for receiving a virtual view identifier, and a virtual view creation system 134 for generating a particular virtual view of a concrete portal site based on a Site Profile (e.g., stored in storage unit 118) referenced by a received virtual view identifier. The referenced Site Profile determines what pages of the concrete portal site are available (e.g., what pages are rendered/hidden/entitled), what portlet instances are displayed on the available pages (e.g., what portlet instances are rendered/hidden/entitled), how the portlet instances behave, and other customization details, as detailed above.

The present invention can be offered as a business method on a subscription or fee basis. For example, one or more components of the present invention can be created, maintained, supported, and/or deployed by a service provider that offers the functions described herein for customers. That is, a service provider can be used to provide virtual views, as described above.

It should also be understood that the present invention can be realized in hardware, software, a propagated signal, or any combination thereof. Any kind of computer/server system(s)—or other apparatus adapted for carrying out the methods described herein—is suitable. A typical combination of hardware and software can include a general purpose computer system with a computer program that, when loaded and executed, carries out the respective methods described herein. Alternatively, a specific use computer, containing specialized hardware for carrying out one or more of the functional tasks of the invention, can be utilized. The present invention can also be embedded in a computer program product or a propagated signal, which comprises all the respective features enabling the implementation of the methods described herein, and which—when loaded in a computer system—is able to carry out these methods.

The invention can take the form of an entirely hardware embodiment, an entirely software embodiment, or an embodiment containing both hardware and software elements. In a preferred embodiment, the invention is implemented in software, which includes but is not limited to firmware, resident software, microcode, etc.

The present invention can take the form of a computer program product accessible from a computer-usable or computer-readable medium providing program code for use by or in connection with a computer or any instruction execution system. For the purposes of this description, a computer-usable or computer-readable medium can be any apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device), or a propagation medium. Examples of a computer-readable medium include a semiconductor or solid state memory, magnetic tape, removable computer diskette, random access memory (RAM), read-only memory (ROM), rigid magnetic disk and optical disk. Current examples of optical disks include a compact disk—read only disk (CD-ROM), a compact disk—read/write disk (CD-R/W), and a digital versatile disk (DVD).

Computer program, propagated signal, software program, program, or software, in the present context mean any expression, in any language, code or notation, of a set of instructions intended to cause a system having an information processing capability to perform a particular function either directly or after either or both of the following: (a) conversion to another language, code or notation; and/or (b) reproduction in a different material form.

The foregoing description of the preferred embodiments of this invention has been presented for purposes of illustration and description. It is not intended to be exhaustive or to limit the invention to the precise form disclosed, and obviously, many modifications and variations are possible. Such modifications and variations that may be apparent to a person skilled in the art are intended to be included within the scope of this invention as defined by the accompanying claims.

What is claimed is:

1. A method for providing virtual views, comprising:
receiving one of a plurality of different virtual view identifiers;
retrieving a site profile associated with the received virtual view identifier; and
uniquely rendering a concrete portal site based on information in the site profile to generate a virtual view of the concrete portal site, wherein a different virtual view of the concrete portal site is rendered for each of the plurality of different virtual view identifiers.

2. The method of claim 1, wherein the information in the site profile includes:
availability of a page of the concrete portal site in the virtual view.

3. The method of claim 2, further comprising:
rendering a default page in the virtual view if the page of the concrete portal site is not available.

4. The method of claim 1, wherein the information in the site profile includes:
availability of a portlet instance on a page of the concrete portal site in the virtual view.

5. The method of claim 4, further comprising:
hiding the portlet instance in the virtual view if the portlet instance is not available.

6. The method of claim 1, wherein the information in the site profile includes:
availability of content on a page or portlet instance of the concrete portal site in the virtual view.

7. The method according to claim 1, wherein the information in the site profile includes:
entitlement to a portion of the concrete portal site in the virtual view.

8. The method of claim 7, further comprising:
selectively rendering the portion of the concrete portal site in the virtual view based on the entitlement.

9. The method of claim 7, wherein the portion of the concrete portal site comprises a page, the method further comprising:
selectively rendering a default page in the virtual view based on a lack of the entitlement.

10. The method of claim 7, wherein the entitlement is selected from the group consisting of user entitlement and group entitlement.

11. The method of claim 1, further comprising:
specifying the virtual view identifier in a Universal Resource Locator (URL) or session.

12. The method of claim 1, wherein the concrete portal site and the virtual view share a navigation node hierarchy.

13. The method of claim 12, further comprising:
selectively suppressing a node of the navigation node hierarchy in the virtual view based on information in the site profile.

14. The method of claim 13, further comprising:
displaying the navigation node hierarchy in the virtual view; and
hiding or making unavailable the suppressed node in the displayed navigation node hierarchy.

15. Deploying an application for providing virtual views, comprising:
providing a computer infrastructure being operable to perform the method of claim 1.

16. Computer software embodied in a propagated signal for providing virtual views, the computer software comprising instructions to cause a computer system to perform the method of claim 1.

17. A system for providing virtual views, comprising:
a system for receiving one of a plurality of different virtual view identifiers;
a system for retrieving a site profile associated with the received virtual view identifier; and
a system for uniquely rendering a concrete portal site based on information in the site profile to generate a virtual view of the concrete portal site, wherein a different virtual view of the concrete portal site is rendered for each of the plurality of different virtual view identifiers.

18. The system of claim 17, wherein the information in the site profile is selected from the group consisting of: availability of a page of the concrete portal site in the virtual view, availability of a portlet instance on a page of the concrete portal site in the virtual view, availability of content on a page or portlet instance of the concrete portal site in the virtual view, and entitlement to a portion of the concrete portal site in the virtual view.

19. The system of claim 18, further comprising:
a system for rendering a default page in the virtual view if the page of the concrete portal site is not available; and
a system for hiding the portlet instance in the virtual view if the portlet instance is not available.

20. A program product stored on a computer readable medium for providing virtual views, the computer readable medium comprising program code for performing the following steps:
receiving one of a plurality of different virtual view identifiers;
retrieving a site profile associated with the received virtual view identifier; and
uniquely rendering a concrete portal site based on information in the site profile to generate a virtual view of the concrete portal site, wherein a different virtual view of the concrete portal site is rendered for each of the plurality of different virtual view identifiers.
